(19) United States
(12) Patent Application Publication
(10) Pub. No.: US 2009/0304442 A1
(43) Pub. Date: Dec. 10, 2009

(54) CONNECTION ASSEMBLY

(75) Inventors: Neil Dennis, Mount Claremont (AU); Benjamin Hughes, Hovea (AU)

Correspondence Address: DRINKER BIDDLE & REATH (DC), 1500 K STREET, N.W., SUITE 1100, WASHINGTON, DC, 20005-1209, US

(73) Assignee: SANDVIK INTELLECTUAL PROPERTY AB, Sandviken (SE)

(21) Appl. No.: 12/158,627

(22) PCT Filed: Dec. 15, 2006
(86) PCT No.: PCT/AU2006/001913

§ 371 Date: Jan. 22, 2009

(30) Foreign Application Priority Data
Dec. 23, 2005 (AU) 2005907262
Jan. 16, 2006 (AU) 2006900187

(51) Int. Cl. F16B 2/14; E02F 9/28

(52) U.S. Cl. 403/374.1

(57) ABSTRACT

A connection assembly for connecting a first member to a second member, such as a wear strip to a portion of an excavating device, is described. The second member has a protruding boss and the first member has a recess complementary in shape to the protruding boss. The first member has an associated first bearing surface and the second member has an associated second bearing surface. The first and second bearing surfaces are, in use, opposed and separated by a tapered gap. The connection assembly further includes a wedge-shaped locking member. The wedge-shaped locking member is sized to locate within the tapered gap and is provided with a driving means to permit tightening or loosening of the locking member within the tapered gap.

### FIELD OF THE INVENTION

The present invention relates to the connection of one mechanical part to another. In a preferred embodiment, the invention relates to the connection of a wear strip to a portion of an excavating device such as an excavator bucket.

### BACKGROUND TO THE INVENTION

It is known that mechanical digging and excavation devices in mining and earthmoving operations are subject to significant wear, caused primarily by high levels of friction and abrasion to excavator buckets, ground engaging tools and similar components. Accordingly, it is generally desirable to be able to replace only a portion of such a component, rather than having to replace an entire device or an entire component.

In order to combat wear of these components, it is known to attach replaceable wear portions to the edges of the components, where the edges or other surface are subject to high wear.

A common method of attaching wear portions is simply to weld a wear portion onto a surface of the component. This has the disadvantage that subsequent removal of a worn wear portion is a relatively complex and time consuming operation. This inevitably leads to reduced efficiency and productivity due to the amount of time that the component is out of operation whilst its wear portions are being replaced.

Mechanical means of attaching wear portions to a device have also been proposed, typically involving the use of pins or bolts. Such methods have often also proved to be ineffective in practice, as the pins or bolts tend to become deformed due to the forces that are placed upon the wear portions and the device to which they are attached. Deformation of the pin or bolt typically makes disengagement of the wear portion from the device difficult, again leading to lost production time and general inefficiency.

It is desirable to be able to attach wear portions to an excavating device component, such as an excavator bucket, in a rigid manner, so that the wear portion does not become loose during operation. It is also desirable to have the ability to readily remove the wear portion, particularly after it has been subjected to stresses during operation.

The present invention attempts to provide an efficacious connection assembly which at least partially meets these desiderata.

### SUMMARY OF THE INVENTION

In accordance with one aspect of the present invention there is provided a connection assembly for connecting a first member to a second member, the second member having a protruding boss and the first member having a complementary shaped recess, wherein the first member has an associated first bearing surface and the second member has an associated second bearing surface, the first and second bearing surfaces, in use, being opposed and separated by a tapered gap, the connection assembly further including a wedge shaped locking member, the wedge shaped locking member being sized to locate within the tapered gap, and driving means arranged to tighten or loosen the locking member within the tapered gap.

In a preferred embodiment, the first member is a wear portion or wear strip and the second member is a portion of a mechanical device component to which wear strips are attached, such as an excavator bucket.

Further preferably, a pair of connection assemblies is provided for attachment of the or each first member to the second member.

Advantageously, the present invention allows for the ready removal and replacement of wear portions, even after subjecting the wear portions to substantial stress.

### BRIEF DESCRIPTION OF THE DRAWINGS

The present invention will now be described, by way of example, with reference to the accompanying drawings, in which:

FIG. 1 is an exploded view of a connection assembly in accordance with the present invention;

FIG. 2(a) is an upper view of a wear strip being connected by the connection assembly of FIG. 1;

FIG. 2(b) is a lower view of the wear strip of FIG. 2a;

FIG. 3(a) is a side view of the connection assembly of FIG. 1 shown prior to assembly;

FIG. 3(b) is a side view of the connection assembly of FIG. 1 shown following assembly;

FIG. 4 is a perspective view of the connection assembly of FIG. 1 during insertion of an engaging member;

FIG. 5 is a perspective view of the connection assembly of FIG. 1 following insertion of the engaging member;

FIG. 6(a) is a partially cut-away view of the connection assembly of FIG. 1 during location of the wear strip;

FIG. 6(b) is a partially cut-away view of the connection assembly of FIG. 1 following location of the wear strip;

FIGS. 7(a), 7(b) and 7(c) are side views of a wedge shaped locking member used in the connection assembly of FIG. 1, shown sequentially during insertion of a cap screw;

FIG. 8 is a perspective view of the connection assembly of FIG. 1 shown during insertion of the wedge shaped locking member;

FIG. 9(a) is a partially cut-away view of the connection assembly of FIG. 1 shown during driving of the wedge shaped locking member;

FIG. 9(b) is a partially cut-away view of the connection assembly of FIG. 1 shown following driving of the wedge shaped locking member; and

FIG. 10 is a cross-sectional view of the connection assembly of FIG. 1 in use.

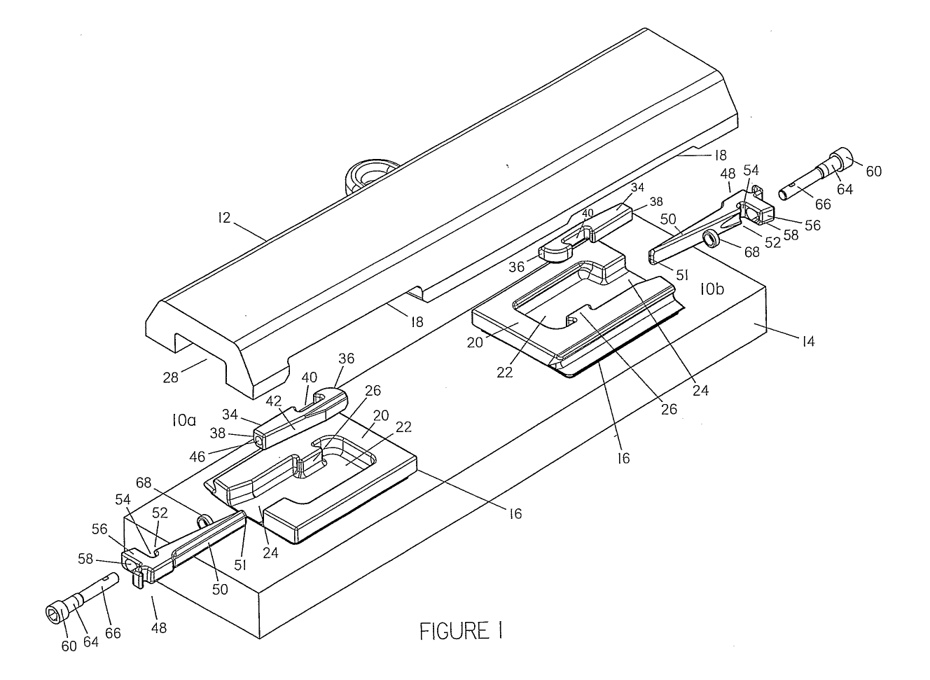

### DESCRIPTION OF A PREFERRED EMBODIMENT

Referring to the Figures, there is shown a connection assembly 10 for connecting a first member such as a wear strip 12 to a second member such as an excavator bucket 14. In the Figures two such connection assemblies 10a and 10b are shown at opposed ends of the wear strip 12.

Each connection assembly 10 includes a protruding boss 16 located on the excavator bucket 14 and a complementary recess 18 within the wear strip 12. Each protruding boss 16 is substantially rectangular, and is formed by an upstanding wall 20. The wall 20 nearly encloses an inner region 22. The wall 20 has a gap 24 that is, in use, oriented towards an end of the wear strip 12 once the wear strip 12 is connected to a portion of excavator bucket 14. Along each of the long arms of the rectangle forming the boss 16, the wall 20 has an outer side and an inner side. A first outer side 17 is on the wall portion extending away from the gap 24. A second outer side 19 is on the opposing wall portion. A first inner side 21a is on the same wall portion as the first outer side 17, only oriented towards the inner region 22. A second inner side 21b is opposed to the first inner side 21a, and is on the same wall portion as the second outer side 19.

The inner region 22 is substantially rectangular, with the gap 24 extending out from the rectangle through one short arm. Other than the gap 24, the rectangular shape of the inner region 22 is only broken by a small lug 26 which extends internally of the inner region 22 at a location along the first inner side 21a.

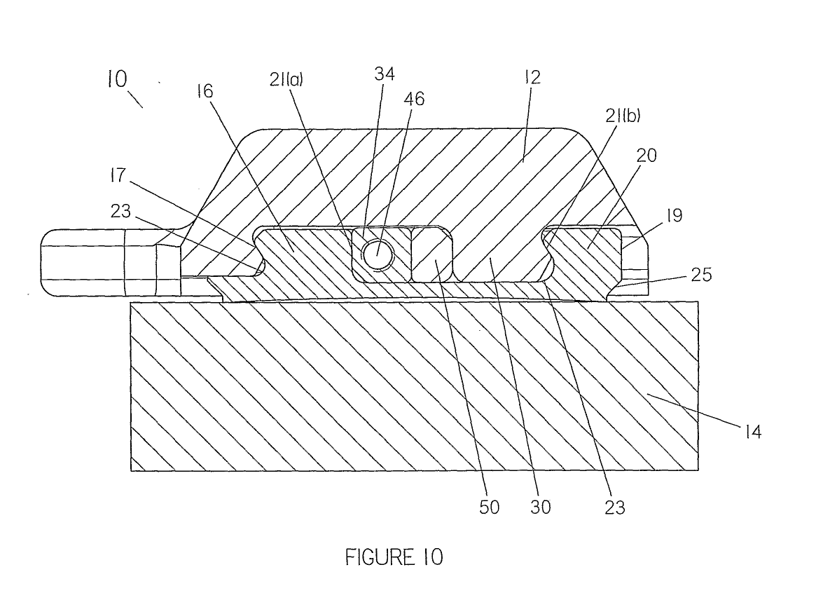

The wall 20 has a varying cross-sectional shape, as can be seen best in FIG. 10. In particular, both the first outer side 17 and the second inner side 21b of the boss 16 taper outwards from a first shoulder 23. The second outer side 19 is shaped to define a second shoulder 25 adjacent the excavator bucket 14. In a preferred embodiment, the second shoulder 25 consists of a bevel, running around the outer of the wall 20, so as to act as a weld preparation. In this regard, the angle of the second shoulder 25 may be varied so as to provide a suitable weld preparation.

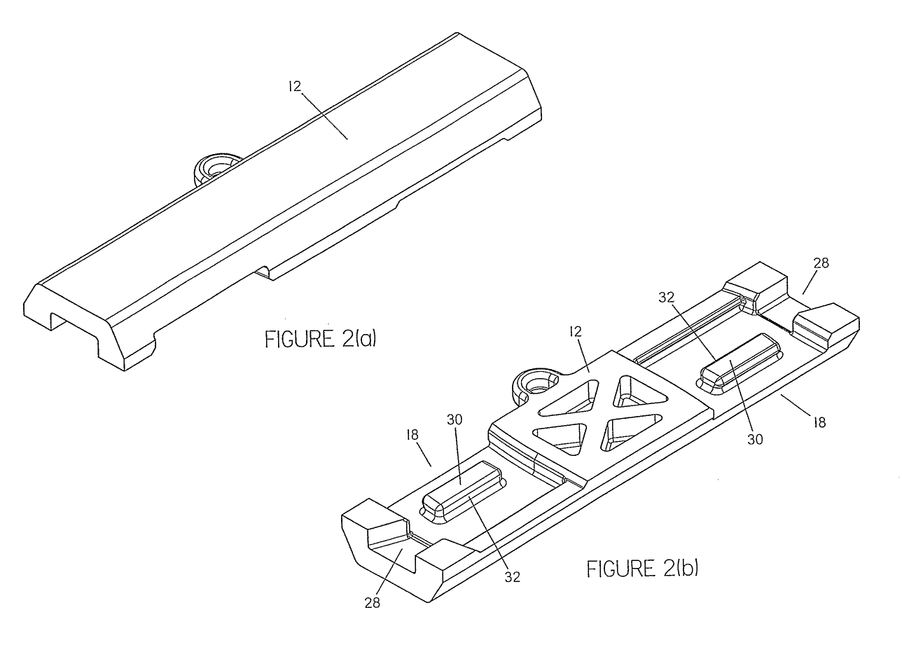

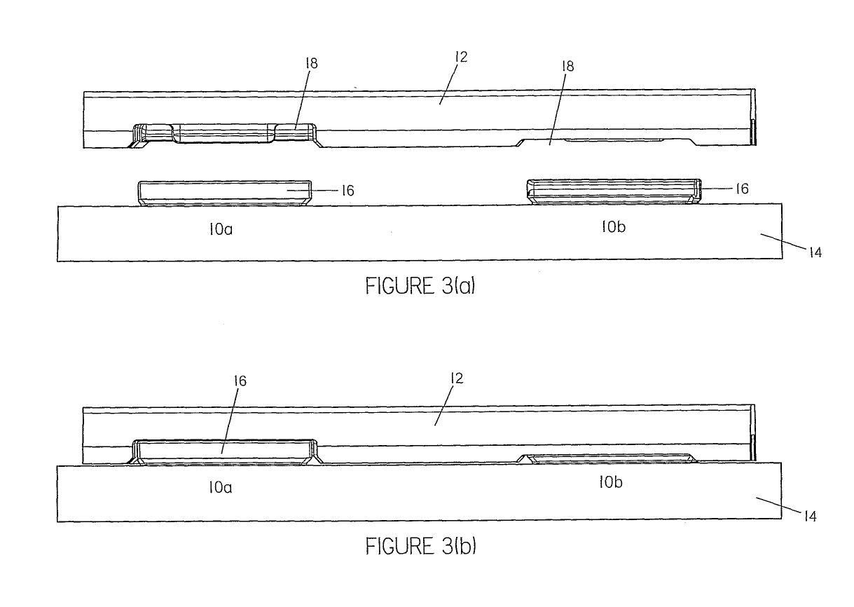

The recesses 18 can best be seen in FIG. 2(b), which shows an underside of the wear strip 12. Each recess 18 extends inwardly of an outer edge of the wear strip 12, with respective recesses 18 of the two connection assemblies 10a, 10b located on opposed outer edges of a single wear strip 12.

Each recess 18 is sized and shaped so as to locate over and about the wall 20 of the associated protruding boss 16. The recess 18 includes an outer gap 28 located on an outer edge of the wear strip 12. The outer gap 28 is similarly sized to the gap 24 of the wall 20, and is located so as to align, in use, with the gap 24.

The recess 18 further includes a bearing member 30. The bearing member 30 is substantially rectangular, with a length similar to the length of the inner region 22 and a width about half that of the inner region 22. In use, the bearing member 30 locates within the inner region 22 adjacent the second inner side 21b, and outside an area of the inner region 22 aligned with the gap 24. The bearing member 30 includes a first bearing surface 32 which is oriented, in use, towards the lug 26. The bearing member 30 has a side wall complementary in shape to the second inner side 21b. The bearing member 30 extends outwardly from a base of the recess 18.

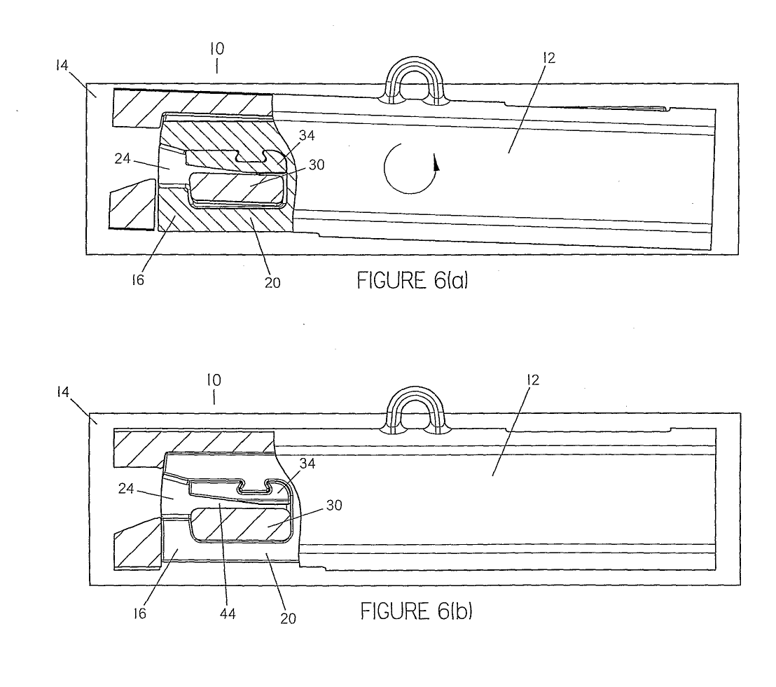

The protruding boss 16 has an engaging member 34 associated therewith. The engaging member 34 is elongate, with an inner end 36 and an outer end 38. The engaging member 34 has a keyhole 40 within one side, which is sized and shaped to fit around and engage with the lug 26. The side of the engaging member 34 opposed to the keyhole 40 acts as a second bearing surface 42. The engaging member 34 is tapered in size, at least partially along the length thereof, from a widest size adjacent the inner end 36 to a narrowest size at the outer end 38. As a result, when the engaging member 34 and the bearing member 30 are both in position, a tapered gap 44 exists between the first bearing surface 32 and the second bearing surface 42, as shown in FIG. 6a.

The engaging member 34 has an internally threaded screw receiving aperture 46 oriented, in use, towards the gap 24.

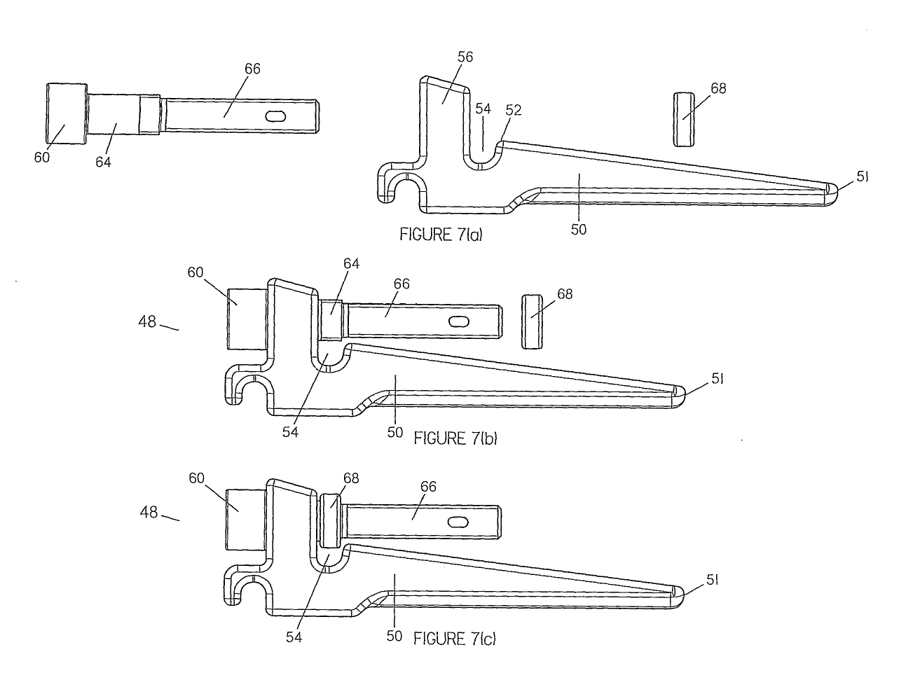

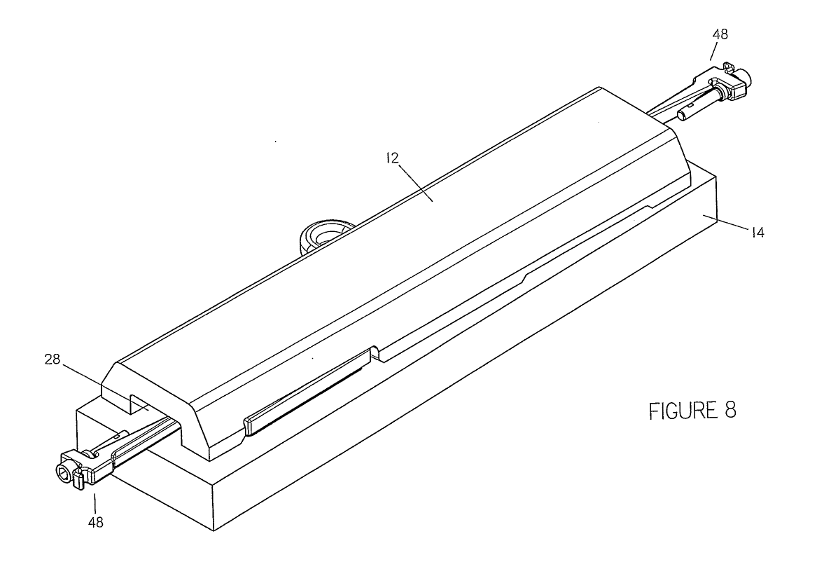

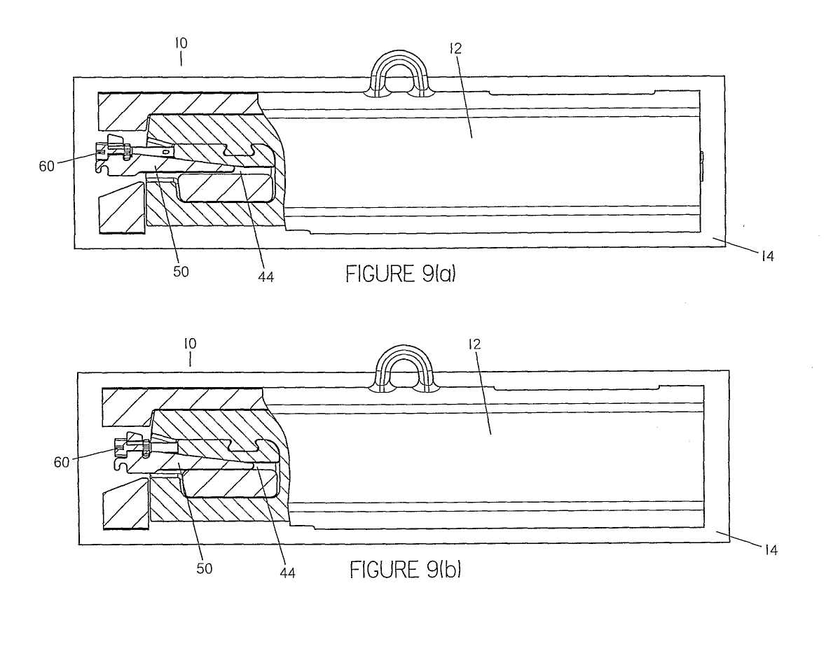

The connection assembly 10 further includes a wedge-shaped locking member 48. The locking member 48 can best be seen in FIGS. 7(a) to 7(c). The locking member 48 includes a wedge shaped locking portion 50 which extends from a narrowest point at an inner edge 51 to a widest point adjacent an outer edge 52. There is a small indent 54 at the outer edge 52. The locking member 48 further includes an engaging portion 56 which extends substantially perpendicularly to the locking portion 50. The engaging portion 56 has a central aperture 58.

The locking member 48 is sized such that the locking portion 50 is sufficiently long to extend within the tapered gap 44. The angle of the wedge of the locking portion 50 is similar to that of the tapered gap 44, such that when the locking portion 50 is inserted into the tapered gap 44 the locking portion 50 will engage both the first and second bearing surfaces 32, 42.

The locking member 48 is associated with a driving means in the form of a cap screw 60. The cap screw 60 has a shaft arranged to pass through the central aperture 58. The shaft has an enlarged portion 64 adjacent the head, and a narrow, externally threaded portion 66 remote from the head. The enlarged portion 64 is arranged to be received within a retaining ring 68, which locates, in use, within the indent 54. The externally threaded portion 66 is arranged to engage within the screw receiving aperture 46. The retaining ring 38 may also optionally be threaded on an inner surface thereof, to facilitate engagement with the enlarged portion 64, however any suitable means for engagement may be utilized.

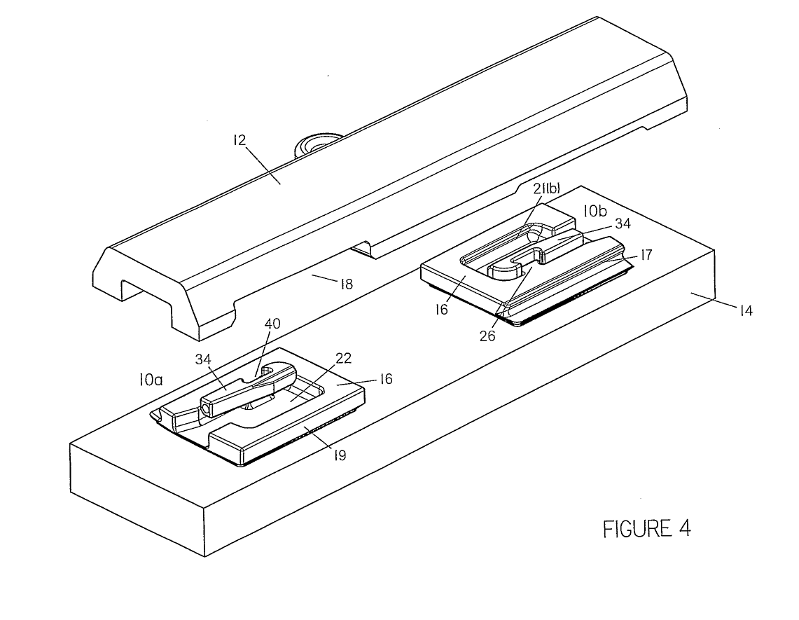

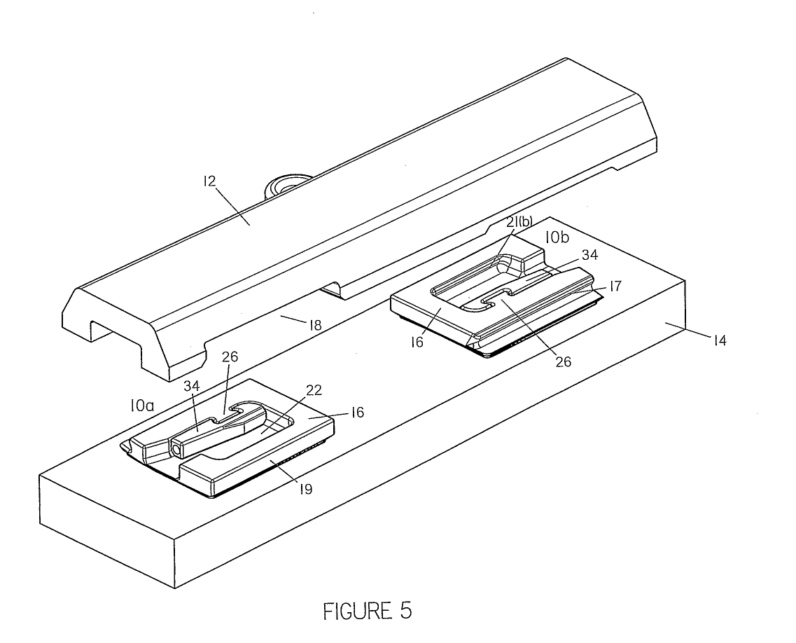

In use, the engaging member 34 is located within the inner region 22 with the keyhole 40 about the lug 26. This is shown in FIGS. 4 and 5.

The wear strip 12 is then brought down toward the excavator bucket 14 such that the protruding boss 16 is located within the recess 18. It will be appreciated that in order for the shoulders 23 to engage with complementary shaped sides of the recess 18, the wear strip must be brought over the boss 16 at an angle, and then twisted into place. This is shown in FIGS. 6(a) and 6(b), with the engagement of the shoulders 23 best seen in FIG. 10. The twisting of the wear strip 12 creates the tapered gap 44. The locking member 48, with cap screw 60 attached, is then introduced into the outer gap 28 and the gap 24, such that the locking portion 50 locates within the tapered gap 44 and the externally threaded portion 66 of the cap screw 60 locates within the screw receiving aperture 46. Tightening of the cap screw 60 thus drives the locking portion 50 further into the tapered gap 44, and ensures the wear strip 12 is securely connected to the excavator bucket 14.

Removal of the wear strip is achieved by reversing the above process.

Modifications and variations as would be apparent to a skilled addressee are deemed to be within the scope of the present invention.

1. A connection assembly for connecting a first member to a second member, the second member having a protruding boss and the first member having a complementary shaped recess, wherein the first member has an associated first bearing surface and the second member has an associated second bearing surface, the first and second bearing surfaces, in use, being opposed and separated by a tapered gap, the connection assembly further including a wedge shaped locking member, the wedge shaped locking member being sized to locate within the tapered gap, and driving means arranged to tighten or loosen the locking member within the tapered gap.

2. A connection assembly according to claim 1, wherein the first bearing surface is located on a bearing member, the bearing member extending outwardly from a base of the recess.

3. A connection assembly according to claim 1, wherein the protruding boss is formed by an upstanding wall, the wall substantially enclosing an inner region in which the bearing member can be received.

4. A connection assembly according to claim 1, wherein the second member includes a removable engaging member, the second bearing surface being located on a surface of the engaging member.

5. A connection assembly according to claim 4, wherein the engaging member has a keyhole on one side, the keyhole arranged to engage with a lug which extends from the protruding boss, and the second bearing surface is arranged on an opposite side of the engaging member to the keyhole.

6. A connection assembly according to claim 1, wherein the protruding boss has a gap aligned, in use, with the tapered gap.

7. A connection assembly according to claim 6, wherein the engaging member is tapered, having a narrowest portion located towards the gap in the upstanding wall, such that when the engaging member and bearing member are in position within the inner region, the tapered gap is created between the first and second bearing surfaces.

8. A connection assembly according to claim 1, wherein the locking member has a wedge shaped locking portion arranged to be received by the tapered gap, and an engaging portion extending substantially perpendicularly to the locking portion.

9. A connection assembly according to claim 8, wherein the angle of the wedge of the locking portion is similar to that of the tapered gap, such that upon insertion of the locking portion into the tapered gap, the locking portion is caused to engage both the first and second bearing surfaces.

10. A connection assembly according to claim 8, wherein the driving means is a cap screw, the cap screw having a shaft arranged to pass through an aperture in the engaging portion of the locking member and engage with a receiving aperture in an end of the narrow portion of the engaging member.

11. A connection assembly according to claim 10, wherein the cap screw has an enlarged portion adjacent a head of the screw and a narrow portion remote from the head, the enlarged portion being receivable within a retaining ring, located in use within an indent in the locking member.

12. A connection assembly according to claim 11, wherein the indent is located at a base of the engaging portion adjacent the locking portion.

13. A connection assembly according to claim 11, wherein the narrow portion of the cap screw is arranged to threadingly engage with the receiving aperture in the engaging member.

14. A connection assembly according to claim 3, wherein sides of the upstanding wall are shaped to define a shoulder, the shoulders being substantially complementary in shape to respective portions of the first member.

15. A connection assembly according to claim 14, wherein an inner side of the wall opposite to the lug is substantially complementary in shape to a corresponding side of the bearing member.

16. A connection assembly according to claim 1, wherein the first member is a wear strip and the second member is a portion of an excavating device.

17. A connection means for connecting a first member to a second member, wherein the first member is connected to the second member by a pair of connection assemblies as claimed in claim 1.
